(19) United States
(12) Patent Application Publication
(10) Pub. No.: US 2025/0371183 A1
(43) Pub. Date: Dec. 4, 2025

(54) SYSTEM ON A CHIP

(71) Applicant: ADVANCED MICRO DEVICES, INC., Santa Clara, CA (US)

(72) Inventors: Mahesh Subramony, Austin, TX (US); David Kramer, Austin, TX (US); Indrani Paul, Austin, TX (US)

(21) Appl. No.: 19/224,429

(22) Filed: May 30, 2025

Related U.S. Application Data
(60) Provisional application No. 63/654,567, filed on May 31, 2024.

(51) Int. Cl. G06F 21/62; G06F 1/3234; G06F 3/06; G06F 13/38; G06F 13/42; G06N 5/04

(52) U.S. Cl. CPC G06F 21/6218; G06F 1/3234; G06F 3/0604; G06F 3/0655; G06F 3/0679; G06F 13/382; G06F 13/4221; G06F 13/4282; G06N 5/04; G06F 2213/0026; G06F 2213/0042

(57) ABSTRACT

A system on chip is configured to operate within a thermal design power (TDP) envelope threshold and form factor (e.g., a TDP envelope and form factor associated with a 10 watt to 15 watt notebook or tablet). The system on chip includes a plurality of central processing unit (CPU) core complexes, each CPU core complex including a last level cache; a parallel processor including a plurality of shader arrays; and an inference processing unit (IPU) including a plurality of inference processing engines (IPEs).

### BACKGROUND

A system on chip (SoC) is an integrated circuit that includes many of the components of a processing device on a single substrate. In many cases, a SoC includes data processing units such as a central processing unit (CPU) and a parallel processor such as a graphics processing unit (GPU), one or more microprocessors or microcontrollers, accelerators, embedded memory, various interfaces supporting communications via different standards such as a Universal Serial Bus (USB) interface or a Peripheral Component Interconnect Express (PCIe) interface, and other components for performing the numerous tasks of the processing device. In this manner, the SoC includes a variety of circuitry components that form a heterogeneous processing system whose performance is constricted by the area available on the SoC substrate and the SoC's thermal design power (TDP) envelope.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is an example of an SoC in accordance with some embodiments.

FIG. 2 is an example of two CPU core complexes (CCXs) of the SoC of FIG. 1 in accordance with some embodiments.

FIG. 3 is an example of a parallel processor (PP) of the SoC of FIG. 1 in accordance with some embodiments.

FIG. 4 is an example of an inference processing unit (IPU) of the SoC of FIG. 1 in accordance with some embodiments.

FIG. 5 is an example of an inference processing engine (IPE) of the IPU of FIG. 4 in accordance with some embodiments.

FIG. 6 is an example diagram of a SoC floorplan in accordance with some embodiments.

### DETAILED DESCRIPTION

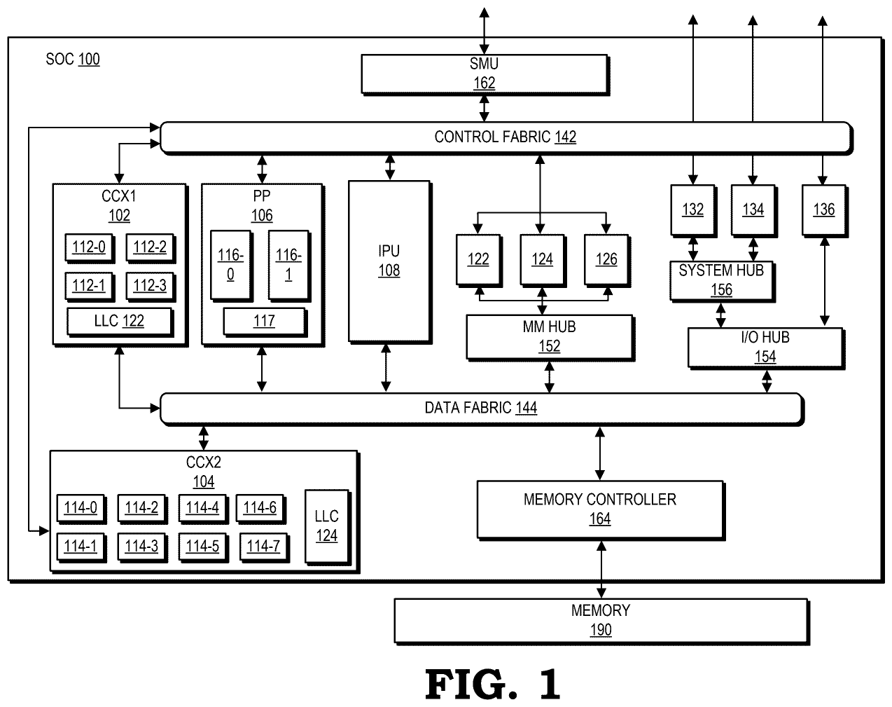

Conventional SoCs for user devices such as laptops typically have a single CPU in addition to other components such as a GPU and one or more hardware accelerators. The performance of SoCs is limited by various factors including the form factor (i.e., the size and shape) of the SoC, the power supplied by the user device, and thermal considerations. FIGS. 1-6 illustrate an SoC that exhibits a performance improvement over other conventional SoCs with a similar form factor and power supply. In particular, the SoC of the present disclosure includes a plurality of CPU core complexes each having a dedicated last level cache (LLC), a parallel processor (PP), and a dedicated inference processing unit (IPU, also referred to as an artificial intelligence (AI) engine, AI processor, or the like). The SoC also includes a scalable control fabric (e.g., such as control fabric 142 of FIG. 1) to control and manage the components of the SoC within particular power range and a TDP envelope and a scalable data fabric (e.g., such as data fabric 144 of FIG. 1) to ensure that the SoC components have access to the data necessary for executing their respective operations. In addition, the SoC includes a variety of microcontrollers and accelerators to manage or control various aspects of the system (e.g., temperature management, security, etc.). In some cases, the components of the SoC implement retention flops for retaining states or data at minimal power without having to perform conventional save-and-restore techniques. In addition, the SoC employs an advanced clocking and power gating technique that enables the selective activation of different partitions of an SoC component (e.g., particular sections within the IPU) on a hierarchical basis in view of a use case.

In some embodiments, the SoC includes multiple features that improve the performance of the SoC within a similar form factor and TDP envelope when compared to conventional SoCs. A first feature of the multiple features is a pair of asymmetric CPU core complexes (CCXs) with each CCX having a dedicated LLC. For example, the first CCX includes a 16 MB LLC and 4 cores that can run up to 8 threads (8T) concurrently. The second CCX includes an 8 MB LLC and 8 cores that can run up to 16T concurrently. The second feature of the multiple features is a PP with up to 8 workgroup processors (WGPs). The third feature is an IPU that, in some embodiments, is configured to execute 16 trillion operations per second (TOPS). In some embodiments, the IPU can execute another range of operations depending on the particular configuration of the inference processing array in the IPU. For example, in some embodiments, the IPU includes an inference processing array having 4×4 inference processing engine (IPE) configuration, and, in other embodiments, the IPU includes an inference processing array having 4×8 IPE configuration.

In some embodiments, the SoC is employed within a user device (e.g., a notebook, laptop, tablet, or other user device) with a TDP envelope threshold. In some embodiments, the TDP envelope threshold is associated with an approximately 10 watt to 15 watt (10 W-15 W) ultrathin notebook or tablet, an approximately 45 watt (45 W) gaming notebook, or an approximately 65 watt (65 W) desktop, for example. In some embodiments, the SoC delivers improved performance compared to conventional SoCs with a similar form factor and TDP envelope. In addition, the components of the SoC include configurable partitions that can be selectively activated based on a use case. This improves SoC performance and efficiency since the unused partitions of a particular component can be placed in a low power state (e.g., higher level partitions in a video encoder can be deactivated or turned off in response to a use case that only requires a lower level partition for, e.g., video encoding).

In some embodiments, the SoC includes other processing or system management components such as a display controller (DCN), a video processing engine (VPE), a video encoder/decoder (VCN), an audio coprocessor (ACP), a memory controller (MC), a system management unit (SMU), a multimedia hub (MM Hub), an input/output hub (I/O Hub), and an image sensor processor (ISP), etc. In addition, the SoC includes microcontrollers for managing the system such as monitoring and maintaining system temperature, security management, remote management, and input/output (I/O) management. Also, in some embodiments, the SoC employs retention flops for retaining states or data at minimal power without having to save-and-restore, thereby reducing the latency associated with the save-and-restore process. The SoC also, in some embodiments, implements advanced clocking and power gating techniques that enable different sections of an SoC component (e.g., particular sections within the IPU or a video encoder/decoder) to be selectively activated on a hierarchical basis in view of a use case. For example, the IPU is partitioned into different power gating regions and the different regions can be selectively activated based on a use case to improve system efficiency. That is, for more computationally intensive tasks, the entire IPU can be activated, whereas less computationally intensive tasks may require the activation of fewer IPU regions.

In some embodiments, any of the elements, components, or blocks shown in the ensuing figures are implemented as one of software executing on a processor, hardware that is hard-wired (e.g., circuitry) to perform the various operations described herein, or a combination thereof. For example, one or more of the described blocks or components represent software instructions that are executed by hardware such as a digital signal processor (DSP), an application-specific integrated circuit (ASIC), a set of logic gates, a field programmable gate array (FPGA), a programmable logic device (PLD), a hardware accelerator, a graphics processing unit (GPU), a neural network (NN) accelerator, an artificial intelligence (AI) accelerator, or other type of hardcoded or programmable circuit.

FIG. 1 illustrates a system on chip (SoC) 100 with multiple CPU core complexes (CCX) 102, 104, a parallel processor (PP) 106, and an inference processing unit (IPU) 108. In some embodiments, the SoC is a single integrated circuit (IC) or a single chip. For example, in some embodiments, the SoC 100 includes a semiconductor substrate on which the illustrated components are formed using fabrication techniques.

In some embodiments, the SoC 100 includes other processing or system management components such as a display controller circuitry (DCN) 122, a video processing engine (VPE) 124, a video encoder/decoder (VCN) 126, an image sensor processor (ISP) (not shown for clarity), a memory controller (MC) 164, a system management unit (SMU) 162, a multimedia hub (MM Hub) 152, an input/output hub (I/O Hub) 154, and a system hub 156. The SoC 100 also includes additional controllers such as one or more USB controllers 132, one or more PCIe controllers 134, and additional controllers 136.

In some embodiments, the multiple CCXs of the SoC 100 includes a first CCX (CCX1) 102 and a second CCX (CCX2) 104. In some cases, the CCX1 102 and the CCX 104 are asymmetric. That is, each of the CCX1 102 and the CCX2 104 includes a different number of cores or processing units. For example, in the illustrated embodiment, the CCX1 102 includes four cores 112-0, 112-1, 112-3, 112-3 (collectively referred to as “cores 112”) and the CCX2 includes eight cores 114-0, 114-1, 114-2, 114-3, 114-4, 114-5, 114-6, 114-7 (collectively referred to as “cores 114”). In some embodiments, each of the cores 112 runs a single-thread (1T) or a multiple thread (e.g., 2T) mode to execute threads including one or more sets of instructions. In some embodiments, each of the cores 112 and the cores 114 includes an internal level 2 (L2) cache. For example, in some embodiments, each one of the cores 112 and the cores 114 includes 1 megabyte (MB) of L2 cache. In addition, the CCX1 102 includes a last level cache (LLC) 122 (e.g., a level 3 (L3) cache) that is shared amongst the cores 112, and the CCX2 104 includes another LLC 124 that is shared amongst the cores 114. In some embodiments, the LLC 122 and the LLC 124 are different sizes. For example, in some embodiments, the LLC 122 is a 16 MB L3 cache, and the LLC 124 is an 8 MB L3 cache. In one embodiment, each of the CCX1 102 and the CCX2 104 is an x86 processor that uses a corresponding complex instruction set. In other embodiments, each of the CCX1 102 and the CCX2 104 is another type of CPU such as an Advanced Reduced Set Instruction Computer (RSIC) Machine (ARM) processor.

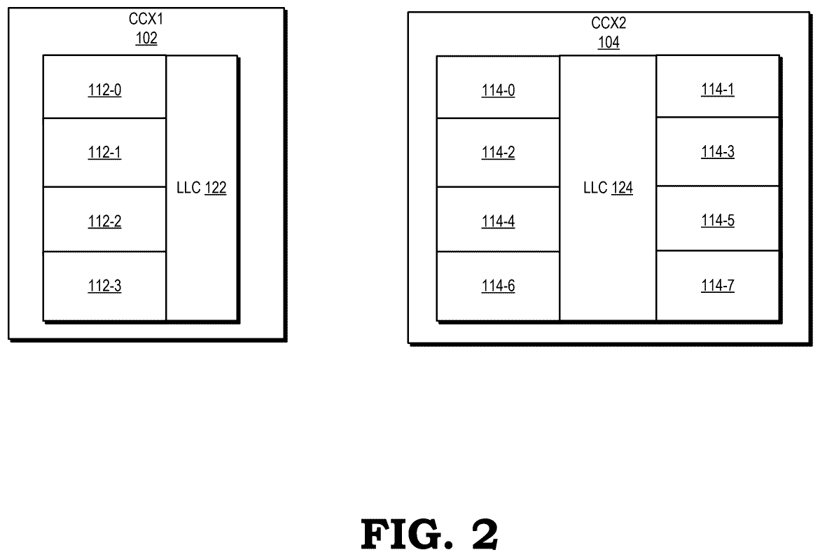

FIG. 2 shows the CCX1 102 on the left and the CCX2 104 on the right according to some embodiments. As shown in FIG. 2, the CCX1 102 includes four cores 112 having compute units (not shown for clarity) to perform tasks based on an instruction set or program code retrieved from a memory and/or from the LLC 122 that is shared among the four cores 112. The CCX2 104 includes eight cores 114 having compute units (not shown for clarity) to perform tasks based on an instruction set or program code retrieved from a memory and/or from the LLC 124 that is shared among the eight cores 114. In addition, in some embodiments, the CCX1 102 and the CCX2 104 support a per-core power gating structure. That is, the CCX1 102 supports a power gating structure that allows for power to be supplied to fewer than all of its cores 112. For example, in some embodiments, the CCX1 102 is configured to provide power to one core, two cores, or three cores of the four cores 112 depending on a use case. This reduces power consumption and improves the efficiency of not only the CCX1 102 but of the entire SoC 100. In some cases, the CCX1 102 implements the power gating structure on a hierarchical basis, where the hierarchy includes a plurality of power states (or power domains). For example, in some embodiments, the CCX1 102 always provides power to the first core 112-0 in a first power state of the plurality of power states to ensure a base level of operations at CCX 102. That is, the first core 112-0 is included in a first power domain within the CCX1 102. The CCX1 102 is also configured to provide power to a subset of the cores 112 (e.g., to the first core 112-0 and the second core 112-1, or to the first core 112-0, the second core 112-1, and the third core 112-2) in other power states of the plurality of power states. For use cases that require maximum performance, the CCX1 102 is configured to provide power to all four cores 112. The CCX2 104 is also configured to provide power to its corresponding eight cores 114 in a similar manner. In some cases, the CCX1 102 or the CCX2 104 is configured to provide power to a subset of its respective cores based on modifying the clock frequency provided to the cores.

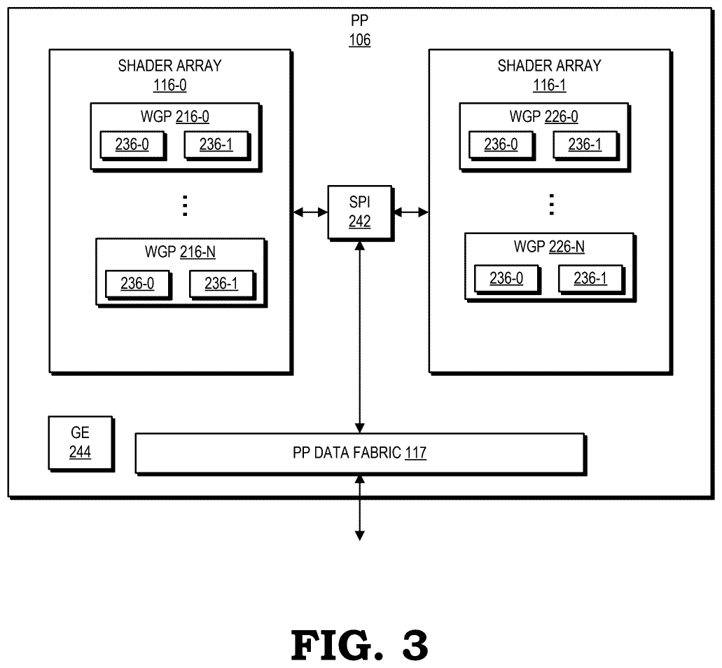

Referring back to FIG. 1, the SoC 100 also includes the PP 106. The PP 106 includes multiple shader arrays (SA) 116-0, 116-1 (collectively referred to as “SAs 116”) configured to perform accelerated processing tasks. For example, in some embodiments, the PP 105 is a graphics processor or graphics engine such as a graphics processing unit (GPU) that performs accelerated graphics and image processing at the SAs 116. In some embodiments, each one of the SAs 116 includes a plurality of workgroup processors (WGPs) as shown in FIG. 3.

In the embodiment illustrated in FIG. 3, the SA 116-0 includes a first plurality of WGPs 216-0 to 216-N, where N is an integer equal to or greater than two, and the SA 116-1 includes a second plurality of WGPs 226-0 to 226-N. In some embodiments, each one of the SAs 116-0, 116-1 includes 4 WGPs (i.e., N=4) for a total of 8 WGPs across the two SAs 116 in the PP 106. In some embodiments, each WGP 216, 226 includes a plurality of compute units 236. Each one of the compute units 236 has a plurality of arithmetic logic units (ALUs) (not shown for clarity). For example, in the illustrated embodiment, each WGP 216 includes two compute units 236-0, 236-1. In some embodiments, each one of the SAs 116 is a physically optimized collection of WGPs that share a pixel pipeline. In addition, the PP 106 includes a PP data fabric 117 for distributing data both within the PP 106 and to components outside of the PP 106 (e.g., to other components of the SoC 100 of FIG. 1) and a shader processor input (SPI) 242 that connects and controls the SAs 116. In some embodiments, the PP 106 also includes a geometry engine (GE) circuitry 244 to provide improved scalability for the primitive and vertex subsystems of the PP 106.

Referring back to FIG. 1, the SoC 100 also includes the IPU 108. The IPU 108 is a complete machine learning accelerator that includes a scalable array of vector processing engines, referred to as inference processing engines (IPEs) connected by a mesh interconnect. In some implementations, the IPU 108 is directly connected to the data fabric 144 and interacts with the other SoC components (e.g., the CCX1 102, the CCX2 104, the PP 106, etc.) to execute its functions and dataflows. The IPU 108 is configured to provide lower power and higher performance machine learning acceleration than would be possible were the workloads running on other SoC components such as one of the CCXs 102, 104 or the PP 106.

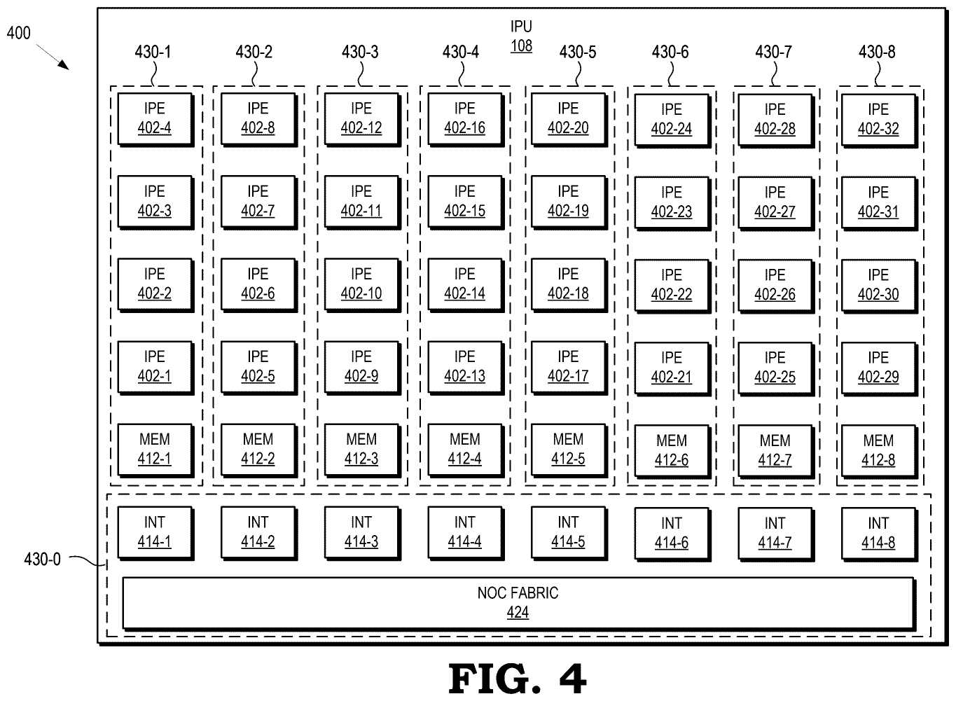

FIG. 4 shows a diagram 400 of the IPU 108 according to some embodiments. In the illustrated embodiments, the IPU 108 includes an inference processing array including a plurality of circuit blocks (also referred to herein as “tiles) such as inference processing engine (IPE) circuits or tiles 402, interface circuits or tiles 414, and memory circuits or tiles 412. In some embodiments, the memory tiles 412 are referred to as shared memory and/or shared memory tiles. In some embodiments, the interface tiles 414 are collectively referred to as an array interface and couple the other tiles of the IPU 108 to a network on chip (NoC) fabric 424 that connects the IPU 108 with the rest of the SoC components.

In one embodiment, the IPEs 402, memory tiles 412, and the interface tiles 414 are in the same power or clock domain. However, in another embodiment, the IPEs 402 are in one power or clock domain while the memory tiles 412 and the interface tiles 414 are in another power or clock domain. This permits the IPU 108 to disable the IPEs 402 while the memory tiles 412 and interface tiles 414 remain operational, and vice versa. In yet another embodiment, the IPEs 402, memory tiles 412, and the interface tiles 414 may each be in their own power or clock domain. In yet another embodiment, each column 430 of the IPEs 402 may each be in its own power or clock domain. This allows for the IPU 108 or an IPU 108 controller (not shown for clarity) to disable a subset of IPEs 402 if they are not needed for a particular use case (e.g., less intensive computational tasks), which conserves power.

In some embodiments, the IPEs 402 include one or more processing cores, program memory (PM), data memory (DM), direct memory access (DMA) circuitry, and stream interconnect (SI) circuitry. For example, the core(s) is the IPEs 402 execute program code stored in the PM. In some embodiments, the core(s) include, without limitation, a scalar processor, a vector processor, or the like. In some embodiments, DM is referred to herein as local memory or local data memory, in contrast to the memory tiles 412 which have memory that is external to the IPEs 402, but still within the IPU 108.

In some embodiments, the core(s) of one IPE 402 may directly access data memory of other IPEs 402 via the DMA circuitry. The core(s) may also access the DM of adjacent (or neighboring) IPEs 402 via the DMA circuitry and/or the DMA circuitry of the adjacent IPEs 402. In one embodiment, the DM in one IPE 402 and the DM of adjacent IPEs 402 is presented to the core(s) as a unified region of memory. In one embodiment, the core(s) in one IPE 402 may access data memory of non-adjacent IPEs 402. In such embodiments, permitting cores to access data memory of other IPEs 402 is useful to share data amongst the IPEs 402.

In some embodiments, the IPU 108 includes direct core-to-core cascade connections (not shown) amongst IPEs 402. Direct core-to-core cascade connections include unidirectional and/or bidirectional direct connections. In some embodiments, core-to-core cascade connections is useful to share data amongst cores of the IPEs 402 with relatively low latency. For example, a direct core-to-core cascade connection may be useful to provide results from an accumulation register of a core of an originating IPE 402 directly to a core(s) of a destination IPE 402.

In an embodiment, IPEs 402 do not include cache memory. Omitting cache memory may be useful to provide predictable/deterministic performance and to reduce processing overhead associated with maintaining coherency among cache memories across the IPEs 402. In an embodiment, processing cores of the IPEs 402 do not utilize input interrupts. Omitting interrupts may be useful to permit the processing cores to operate uninterrupted and to provide predictable and/or deterministic performance.

In some embodiments, one or more of the IPEs 402 includes special purpose or specialized circuitry or is configured as special purpose or specialized compute tiles such as, without limitation, digital signal processing engines, cryptographic engines, forward error correction (FEC) engines, or artificial intelligence (AI) engines. In an embodiment, the IPEs 402, or a subset thereof, are substantially identical to one another (i.e., homogenous IPEs). Alternatively, one or more of the IPEs 402 may differ from one other more other ones of the IPEs 402 (i.e., heterogeneous IPEs).

In some embodiments, one or more of the memory tiles 412 includes memory (e.g., random access memory or RAM), DMA circuitry, and stream interconnect (SI) circuitry. In some embodiments, the memory tiles 412 may lack or omit computational components such as an instruction processor. In an embodiment, the memory tiles 412, or a subset thereof, are substantially identical to one another (i.e., homogenous memory tiles). Alternatively, one or more of the memory tiles 412 may differ from other ones of the memory tiles 412 (i.e., heterogeneous memory tiles). A memory tile 412 may be accessible to multiple IPEs 402 and may thus be referred to as shared memory.

In some embodiments, data is moved between or amongst the memory tiles 412 via DMA circuitry and/or stream interconnect circuitry of the respective memory tiles 412. In some embodiments, data is moved between or amongst data memory of an IPE 402 and a memory tile 412 via DMA circuitry and/or stream interconnect circuitry of the respective tiles. For example, the DMA circuitry in an IPE 402 may read data from its data memory and forward the data to a memory tile 412 in a write command, via stream interconnect circuitry in the IPE 402 and stream interconnect circuitry in the memory tile 412. The DMA circuitry of memory tile 412 may then write the data to its memory. As another example, the DMA circuitry of memory tile 412 may read data from its memory and forward the data to an IPE 402 in a write command, and DMA circuitry in the IPE 402 can write the data to its data memory.

In some embodiments, the interface tiles 414 interface between the IPEs 402 and memory tiles 412 and the NoC 424. In some embodiments, each one of the interface tiles 414 includes DMA circuitry and SI circuitry. In some cases, the interface tiles 414 are interconnected so that data is propagated amongst the interface tiles 414 bi-directionally. In some embodiments, an interface tile 414 operates as an interface for a column of IPEs 402 (e.g., such as interface tile 414-1 for the IPEs 402 in column 430-1) to the NoC 424.

In an embodiment, the interface tiles 414, or a subset thereof, are substantially identical to one another (i.e., homogenous interface tiles). Alternatively, one or more interface tiles 414 may differ from other ones of the interface tiles 704 (i.e., heterogeneous interface tiles).

In an embodiment, one or more interface tiles 414 is configured as a NoC interface tile (e.g., as master and/or slave device) that interfaces between the IPEs 402 and the NoC 424 (e.g., to access other components in the SoC). For example, in one embodiment, each of the interface tiles 414 is connected to the NoC 424. Doing so may permit different applications to control and use different columns of the memory tiles 412 and IPEs 402.

In some embodiments, the DMA circuitry and the SI circuitry of the IPU 108 is configurable to provide desired functionality or connections to move data between or amongst the IPEs 402, the memory tiles 412, and the NoC 424. In some embodiments, the DMA circuitry and SI circuitry of the IPU 1-8 includes any combination of switches or multiplexers that are configurable to establish signal paths within, amongst, and/or between tiles of the IPU 108. The IPU 108 may further include configurable Advanced extensible Interface (AXI) circuitry. In some embodiments, the DMA circuitry, the SI circuitry, and/or the AXI interface circuitry is configured by storing configuration parameters in configuration registers, configuration memory (e.g., configuration random access memory or CRAM), and/or eFuses, and coupling read outputs of the configuration registers, CRAM, and/or eFuses to functional circuitry (e.g., to a control input of a multiplexer or switch), to maintain the functional circuitry in a desired configuration or state. In an embodiment, the core(s) of IPEs 402 configure the DMA circuitry and SI circuitry of the respective IPEs 402 based on core code stored in PM of the respective IPEs 402. In some embodiments, a controller (not shown) configures the DMA circuitry and the SI circuitry of the memory tiles 412 and the interface tiles 414 based on controller code.

In some embodiments, the IPU 108 includes a hierarchical memory structure. For example, data memory of the IPEs 402 may represent a first level (L1) of memory, memory of the memory tiles 412 may represent a second level (L2) of memory, and external memory outside the IPU 108 may represent a third level (L3) of memory. Memory capacity may progressively decrease with each level.

In some embodiments, the IPU 108 is a medium-edge inference accelerator suited for offload machine learning algorithms deployed across applications such as computation photography applications (e.g., image enhancement, super resolution, etc.), video conferencing applications (e.g., background blur, virtual background, face detection, audio noise suppression, eye gaze correction, auto face framing, etc.), multi-modal perception applications (e.g., hand gesture tracking, gaze tracking, etc.), and productivity applications (e.g., speech-to-text, word completion, search and indexing, etc.). In some embodiments, the IPU 108 is a default off component. That is, in some implementations from a system perspective, one or both of the CCXs 102, 104 utilize the IPU 108 as an offload processor and control the IPU 108 accordingly. In some embodiments, the IPU 108 implements an internal power delivery and internal power gating structure. For example, in some embodiments, the IPU 108 includes different power gating regions corresponding to each of the sections 430 (e.g., including row 430-0 and columns 430-1 to 430-8). The IPU 108 is configured to selectively activate one or more of the sections 430 based on a use case. For example, for more computationally complex tasks, the IPU 108 is configured to deliver power to all of the regions 430-0 to 430-8. On the other hand, for example, for tasks with minimal complexity or to enter into a low power state, the IPU 108 is configured to deliver power to regions 430-0 and 430-1 or only to region 430-0, respectively.

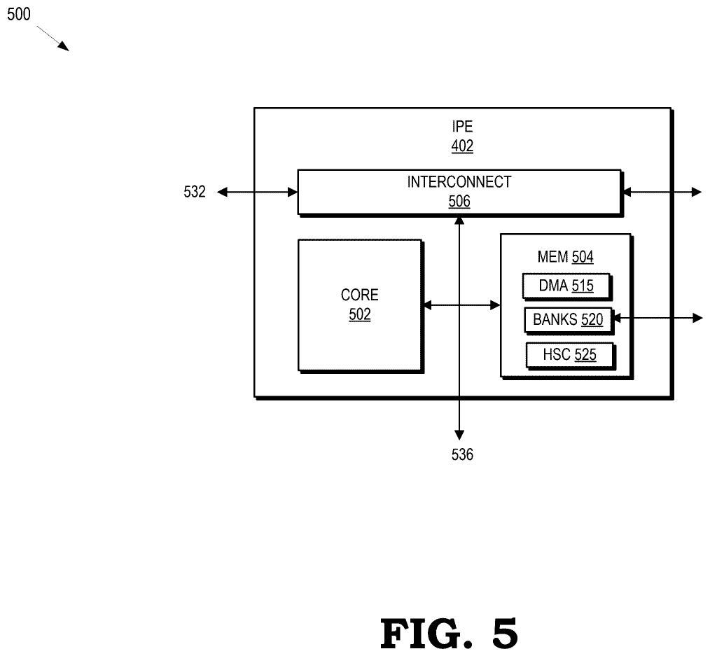

FIG. 5 is a block diagram 500 of an inference processing engine (IPE) 402 of FIG. 4 in accordance with some embodiments. The IPE 402 includes an interconnect 506, a core 502, and a memory 504. The interconnect 506 permits data to be transferred from the core 502 and the memory 504 to different cores in the IPU 108 in directions 532, 534, 536, for example. That is, the interconnect 506 in each of the neighboring IPEs 402 of the IPU 108 shown in FIG. 4 is connected to each other so that data can be transferred north and south (e.g., up and down) as well as east and west (e.g., right and left) between the IPEs 402.

For example, the IPEs 402 in an upper row of the array rely on the interconnects 506 in the IPEs 402 in a lower row to communicate with the NoC 424 shown in FIG. 4. For example, to transmit data to the NoC 424, a core 502 in an IPE 402 in the upper row transmits data to its interconnect 506 which is in turn communicatively coupled to the interconnect 506 in an IPE 402 in the lower row. The interconnect 506 in the lower row is connected to the NoC 424. The process may be reversed where data intended for an IPE 402 in the upper row is first transmitted from the NoC 424 to the interconnect 506 in the IPE 402 in a lower row and then to the interconnect 506 of the IPE 402 in the upper row that is the target IPE 402. In this manner, the IPEs 402 in the upper rows may rely on the interconnects 506 in the IPEs 402 in the lower rows to transmit data to and receive data from the NoC 424.

In one embodiment, the interconnect 506 includes a configurable switching network that permits the user to determine how data is routed through the interconnect 506. In one embodiment, unlike in a packet routing network, the interconnect 506 may form streaming point-to-point connections. That is, the streaming connections and streaming interconnects (not shown) in the interconnect 506 may form routes from the core 502 and the memory 504 to the neighboring IPEs 402 or the NoC 424. Once configured, the core 502 and the memory 504 can transmit and receive streaming data along those routes. In one embodiment, the interconnect 506 is configured using the AXI Streaming protocol. However, when communicating with the NoC, the IPEs 402 may use the AXI memory mapped (MM) protocol.

In addition to forming a streaming network, in some embodiments, the interconnect 506 includes a separate network for programming or configuring the hardware elements in the IPE 402. Although not shown, in some embodiments, the interconnect 506 includes a memory mapped interconnect (e.g., AXI MM) which includes different connections and switch elements used to set values of configuration registers in the IPE 402 that alter or set functions of the streaming network, the core 502, and the memory 504.

In one embodiment, streaming interconnects (or network) in the interconnect 506 support two different modes of operation referred to herein as circuit switching and packet switching. In one embodiment, both of these modes are part of, or compatible with, the same streaming protocol—e.g., an AXI Streaming protocol. Circuit switching relies on reserved point-to-point communication paths between a source IPE 402 to one or more destination IPEs 402. In one embodiment, the point-to-point communication path used when performing circuit switching in the interconnect 506 is not shared with other streams (regardless of whether those streams are circuit switched or packet switched). However, when transmitting streaming data between two or more IPEs 402 using packet-switching, the same physical wires can be shared with other logical streams.

In some embodiments, the core 502 includes hardware elements for processing digital signals. For example, the core 502 is used to process signals related to wireless communication, radar, vector operations, machine learning applications, and the like. As such, the core 502 includes program memories, an instruction fetch/decode unit, fixed-point vector units, floating-point vector units, arithmetic logic units (ALUs), multiply accumulators (MAC), and the like. However, in other embodiments, the hardware elements in the core 502 may change depending on the engine type of the IPU 108.

In the illustrated embodiment, the memory 504 includes a DMA circuit 515, memory banks 520, and hardware synchronization circuitry (HSC) 525 or other type of hardware synchronization block. In one embodiment, the DMA circuit 515 enables data to be received by, and transmitted to, the interconnect 506. That is, the DMA circuit 515 is used to perform DMA reads and write to the memory banks 520 using data received via the interconnect 506 from the NoC or other IPEs 402 in the array.

In some embodiments, the memory banks 520 can include any number of physical memory elements (e.g., SRAM). For example, the memory 504 may include 4, 8, 16, 32, etc. different memory banks 520. In some embodiments, the core 502 has a direct connection to the memory banks 520. Stated differently, the core 502 can write data to, or read data from, the memory banks 520 without using the interconnect 506.

In one embodiment, the memory 504 also has direct connections 518 to cores in neighboring IPEs 402. Put differently, a neighboring IPE in the array can read data from, or write data into, the memory banks 520 using the direct neighbor connections 518 without relying on their interconnects 506. In some embodiments, the HSC 525 is used to govern or protect access to the memory banks 520. In one embodiment, before the core 502 or a core in a neighboring IPE can read data from, or write data into, the memory banks 520, the core (or the DMA engine 515) requests a lock acquire to the HSC 525 when it wants to read or write to the memory banks 520 (e.g., when the core/DMA engine want to “own” a buffer, which is an assigned portion of the memory banks 520). If the core or DMA engine does not acquire the lock, the HSC 525 will stall (e.g., stop) the core or DMA engine from accessing the memory banks 520. When the core or DMA engine is done with the buffer, they release the lock to the HSC 525. In one embodiment, the HSC 525 synchronizes the DMA engine 515 and core 502 in the same IPE 402. Once the write is complete, the core (or the DMA engine 515) can release the lock which permits cores in neighboring IPEs 402 to read the data.

In some embodiments, because the core 502 and the cores in neighboring IPEs 402 can directly access the memory 504, the memory banks 520 can be considered as shared memory between the IPEs 402. That is, the neighboring IPEs can directly access the memory banks 520 in a similar way as the core 502 that is in the same IPE 402 as the memory banks 520. Thus, if the core 502 wants to transmit data to a core in a neighboring IPE, the core 502 can write the data into the memory bank 520. The neighboring IPE can then retrieve the data from the memory bank 520 and begin processing the data. In this manner, the cores in neighboring IPEs 402 can transfer data using the HSC 525 while avoiding the extra latency introduced when using the interconnects 506. In contrast, if the core 502 wants to transfer data to a non-neighboring IPE in the array (e.g., to an IPE without a direct connection 518 to the memory 504), the core 502 uses the interconnects 506 to route the data to the memory of the target IPE which may take longer to complete because of the added latency of using the interconnect 506 and because the data is copied into the memory of the target IPE rather than being read from a shared memory module.

In some embodiments, in addition to sharing the memory 504, the core 502 has a direct connection to cores 502 in neighboring IPEs 402 using a core-to-core communication link (not shown). That is, instead of using either a shared memory 504 or the interconnect 506, the core 502 transmits data to another core in the array directly without storing the data in a memory 504 or using the interconnect 506 (which can have buffers or other queues). For example, communicating using the core-to-core communication links may use less latency (or have high bandwidth) than transmitting data using the interconnect 506 or shared memory (which requires a core to write the data and then another core to read the data) which can offer more cost effective communication. In one embodiment, the core-to-core communication links transmits data between two cores 502 in one clock cycle. In one embodiment, the data is transmitted between the cores on the link without being stored in any memory elements external to the cores 502. In one embodiment, the core 502 transmits a data word or vector to a neighboring core using the links every clock cycle.

In one embodiment, the communication links are streaming data links which permit the core 502 to stream data to a neighboring core. Further, the core 502 can include any number of communication links which can extend to different cores in the array. In this example, the IPE 402 has respective core-to-core communication links to cores located in IPEs in the array that are to the right and left (east and west) and up and down (north or south) of the core 502. However, in other embodiments, the core 502 in the IPE 402 illustrated in FIG. 5 also has core-to-core communication links to cores disposed at a diagonal from the core 502.

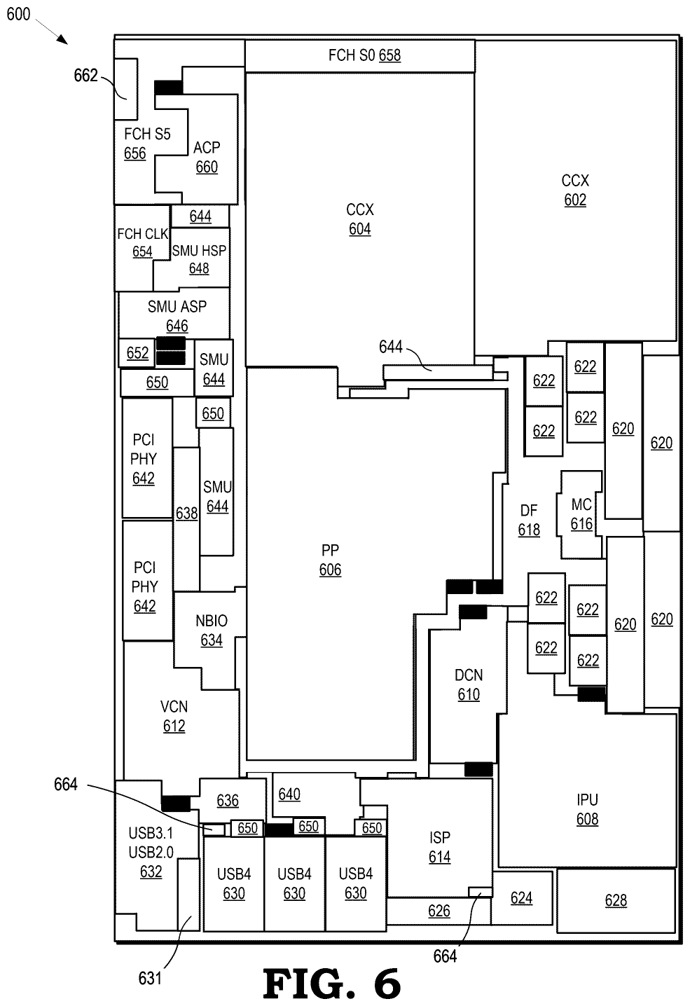

FIG. 6 shows an example of a floorplan (layout) of a SoC 600 in accordance with some embodiments. The SoC 600, in some embodiments, is an accelerated processing unit (APU) that combines both central processing unit (CPU) and graphics processing unit (GPU) capabilities within a single chip. In some cases, the SoC 600 is an APU that covers a wide power range from 10 W ultrathin notebooks up to 65 W desktops. For example, in one embodiment, the SoC 600 is implemented in a user device (such as a notebook or a 2-in-1 laptop) with a limited TDP envelope ranging from about 10 W to about 25 W and a limited form factor (i.e., the size, shape, and associated physical specifications of the user device). In some embodiments, the SoC 600 is a full monolithic die manufactured according to a four nanometer (4 nm) process (N4 process). In some embodiments, the SoC 600 has dimensions to fit within a form factor threshold size. For example, in some embodiments, the form factor threshold size is about 15 mm×25 mm or less, e.g., about 12 mm×19 mm.

In the illustrated embodiment, the SoC 600 includes two CPU core complexes (CCXs) 602, 604. For example, in some embodiments, the CCXs 602, 604 correspond to the CCX1 102 and the CCX2 104 of FIGS. 1 and 2. The SoC 600 also includes a parallel processor (PP) 606. For example, in some embodiments, the PP 606 corresponds to the PP 106 of FIGS. 1 and 3. The SoC 600 also includes an IPU 608, which in some cases, corresponds to the IPU 108 of FIGS. 1 and 4.

In the illustrated embodiment, the SoC 600 also includes a display controller (DCN) 610, which in some cases corresponds to the DCN 122 of FIG. 1. The DCN 610, in some embodiments, includes one or more functional blocks including a DCN memory hub (DCHUB) to SoC data fabric client interface via an SDP port, a DCN multimedia hub client interface via an AXI4 port, a display pipe and plane (DPP), a multimedia plane combiner, an output processing block, a display stream compressor, an output timing combiner, display input/output (IO) encoders, a high-definition (HD) audio block, a display controller management unit, a high performance output block, a DCN clock generator, a display port input adapter, and a DCN low power control block. In addition, the DCN 610, in some embodiments, includes one or more SoC interfaces, external display IO interfaces, and external audio IO interfaces. The DCN 610, in some cases, also includes DCN input/output (IO) terminals 628 to enable the DCM 610 to communicate with external components.

In some embodiments, the DCN 610 supports advanced clocking and power gating techniques for its components similar to the advanced clocking and power gating techniques described herein. In addition, in some embodiments, the DCN 610 includes support for an interface that provides connectivity from a security processor key manager block to an encryption key block or VCN consumer which may be physically anywhere within the SoC floorplan with a goal to provide for global distribution while minimizing the use of hardware and clock resources.

In the illustrated embodiment, the SoC 600 also includes a video encoder and decoder circuitry (VCN) 612. In some embodiments, the VCN 612 includes encoding circuitry for encoding one or more video frames along with any associated audio data and metadata to generate encoded bitstreams according to one or more advanced video coding (AVC) or other compression standards (e.g., H.264, HEVC, JPEG, AOMedia Video 1 (AV1), or the like). For example, in some embodiments, the VCN 612 includes encoding circuitry for AV1 encoding at up to a 160 Mpbs bitrate, HEVC encoding at up to a 100 Mbps bitrate, and H.264 encoding at up to a 100 Mbps bitrate. The VCN 612 also includes decoding circuitry for decoding one or more video frames along with any associated audio data and metadata to generate decoded bitstreams according to the one or more AVC or other compression standards. For example, in some embodiments, the VCN 612 includes decoding circuitry for AV1 decoding at up to a 60 Mbps bitrate, HEVC decoding at up to a 137 Mbps bitrate, VP9 decoding at up to a 150 Mbps bitrate, and H.264 decoding at up to a 170 Mbps bitrate. In some embodiments, the VCN 612 supports advanced clocking and power gating techniques for its components similar to the advanced clocking and power gating techniques described herein. In addition, in some embodiments, the VCN 612 includes support for an interface that provides connectivity from a security processor key manager block to the encryption key IP/VCN consumer which may be physically anywhere within the SoC floorplan. Furthermore, in some cases, this is performed with a goal to provide for the capability to distribute globally while minimizing the use of hardware and clock resources.

In the illustrated embodiment, the SoC 600 also includes an image sensor processor (ISP) 614. The ISP 614 is a hardware subsystem which receives pixel data from an external discrete image sensor via a Mobile Industry Processor Interface (MIPI) interface, and writes image processed data to the external memory (e.g., DDR/LPDDR) for subsequent processing via applications. The ISP 614 implements a pipeline that includes multiple hardware components interconnected via a streaming interface. The pipeline is capable of handling video/image preview, image capture, and streaming video, for example. In some embodiments, the ISP 614 offloads certain tasks to the IPU 608 for certain AI based image enhancement features such as low-light spatial denoising, super-resolution, image segmentation, and the like. In some embodiments, the ISP 614 supports advanced clocking and power gating techniques for its components similar to the advanced clocking and power gating techniques described herein. In the illustrated embodiment, the SoC 600 also includes a mobile industry processor interface (MIPI) 624 or other ISP pads 626 for interconnecting components within the SoC 600 or connecting the SoC 600 with external components such as cameras, displays, or other peripherals.

To facilitate the dispatch of read and write requests to memory (e.g., DRAM) in a manner that optimizes the latency of time critical requests and data bus bandwidth, the SoC 600 also includes a memory controller (MC) 616. In some embodiments, the MC 616 implements a plurality of unified memory controller (UMS) instances, each supporting a 32b memory interface channel. The MC 616, in some embodiments, supports both LPDDR5 or DDR5 memories. In some cases, for LPDDR5, the MC 616 supports 2 or 4 32b channels, up to 2 ranks per channel, and up to a 7500 MT/s data rate. In some cases, for DDR5, the MC 616 supports 2 or 4 32b channels, UDIMM or SODIMM support, up to 4 ranks per channel, up to a 5600 MT/s data rate, and support for 4b EXX per 32b channel. Furthermore, in some embodiments, the MC 616 includes security components for one or more of AES-128 encryption support or 129-bit GF multiply. In some embodiments, the MC 616 supports advanced clocking and power gating techniques for its components similar to the advanced clocking and power gating techniques described herein.

The SoC 600 also includes a data fabric (DF) 618 (also referred to as an “interconnect fabric”) that allows for different components on the SoC 600 to communicate and share data with one another. The DF 618, for example, corresponds to the data fabric 144 of FIG. 1. In some embodiments, the DF 618 has a data path width of 256 bits, but in other embodiments, the DF 618 may have a different data path width dependent on different use case scenarios. For example, the DF 618 supports up to 120 GB/s peak memory throughput for graphics performance and includes a system probe filter for reduced CPU probe traffic. In addition, in some aspects, the DF 618 provides support for 40 physical address bits. Additional functions of the DF 618 include providing CPU access to DRAM, MMIO, and PCI configuration space; providing a full bandwidth data path between graphics and memory; and providing a data path for internal PCIe devices to and from the memory and the host x86 processor. The DF 618, in some cases, provides I/O coherent access to DMA devices in the SoC 600. The DF 618 also provides services such as cache coherent communication between the CCXs 602, 604 and the parallel processor 606, a global ordering point for the SoC 600, and Quality of Service (QOS) for both hard real time and soft real time multimedia devices.

In the illustrated embodiment, the SoC 600 also includes a plurality of memories 620. For example, in some embodiments, the plurality of memories 620 are double data rate synchronous dynamic random-access memories (DDR SRAMs, or DDR for short). In the illustrated embodiment, the plurality of memories 620 include four Double Data Rate 5 Synchronous Dynamic Random-Access Memory (DDR5 SDRAM, or DDR5 for short) integrated memory circuits. In some embodiments, the MC 616 manages the read and write requests issued to the plurality of memories 620. In some embodiments, the plurality of memories 620 support advanced clocking and power gating techniques for its components similar to the advanced clocking and power gating techniques described herein. In the illustrated embodiment, the SoC 600 includes additional memory components 622 to implements a cache hierarchy, for example. The plurality of memories 620 may support advanced clocking and power gating techniques for its components similar to the advanced clocking and power gating techniques described herein.

To provide fast data transfer speeds, improved display capabilities, and/or enhanced power delivery over USB-C type connectors, the SoC 600 also includes one or more Universal Serial Bus (USB) 4 (USB4) components 630. The USB4 components 630 include USB4 ports to enable high-speed data links in the range of 20 Gbit/s, 40 Gbit/s, and 80 Gbit/s, for example, and also include the associated USB4 control circuitry. The SoC 600, in some embodiments, also includes a USB4 auxiliary component (AUX) 631 to provide auxiliary USB4 support. In some cases, the SoC 600 also includes other USB components 632 such as USB3.1 or USB2.0 components (e.g., including ports and/or the associated USB control circuitry). In some embodiments, the SoC 600 includes other types of combinations of USB components.

In the illustrated embodiment, the SoC 600 also includes a Northbridge I/O (NBIO) subsystem 634 to implement a design hierarchy that assembles a collection of NBIO functional blocks to build a high performance PCIe-compatible I/O interconnect for the SoC 600. In general, the NBIO subsystem 634 provides PCIe connectivity to external devices as well as Advanced extensible Interface (AXI) based components of the SoC 600. The NBIO subsystem 634 implements Session Description Protocol (SDP) interfaces on the DF 618 and fusion controller hub (FCH) data paths while Session Management Network (SMN) interfaces are used for register access through the Remote-SMU module 644. In some embodiments, the NBIO subsystem 634 includes input/output hub (IOHUB) blocks, PCIe controllers, New Bridge Interface (nBIF) blocks, and System Hub circuitry. In the illustrated embodiment, the NBIO subsystem 634 also includes NBIO USB4 functional blocks 636 for interfacing with the USB4 components 630 and NBIO PCIe functional blocks 638 for PCIe interfaces.

For operating system and driver support such as host data paths and interrupt handlers as well as a lite System Direct Memory Access (L-SDMA) engine, the SoC 600 also includes additional hubs and system interfaces 640. In some embodiments, the SoC 600 also includes Peripheral Component Interconnect (PCI) physical layer (PHY) components 642 which include control circuitry and ports for PCIe interfaces. For example, in some embodiments, the PCI PHY components 642 determine the number of lanes (e.g., 8 lanes) to transmit on based on the number of receiver lanes from a training sequence and a size of the transmit port. The PCI PHY components 642, in some embodiments, also handle link initialization (e.g., for state machines, counters, training set generation), multi-byte/symbol to lane assignment, lane alignment for headers, link speed negotiation (2.5 GT/s, 5 GT/s, 8 GT/s, 16 GT/s), link degradation and reconfiguration, lane reversal, data scrambling, and loopback, for example.

In the illustrated embodiment, the SoC 600 includes system management unit (SMU) 644. The SMU 644 is the system management complex which includes memory protection and system protection (MPASP) and other security processor circuitry for firmware-controlled functions as well as fixed function blocks for SoC management and control functions like voltage regulation control, thermal control, and the like. In some embodiments, from the SoC 600 perspective, the SMU 644 includes hardware circuitry and the corresponding code that runs on it. For example, the SMU 644 includes the hardware controllers for sequencing and save/restore functions and provides other hardware capabilities to advance the SoC capabilities such as wireless management and the like. In the illustrated embodiment, the SMU 644 includes the SMU ASP (e.g., a root of trust security processor) 646 configured to generate and protect root and certificate authority keys and the SMU HSP (peripheral security processor) 648 configured to manage security-related tasks for peripheral components.

To select between different SoC 600 power modes, the SoC 600 includes power multiplexers (PWRMUXs) 650. In some cases, the PWRMUXs 650 enable for power management to provide an ultra-low power retention mode and to enable fast entry and exit latency from power states. In the illustrated embodiments, the SoC 600 includes PWRMUXs 650 for the PCIe controllers, graphics retention RAMs, and the USB4 controllers. Additionally, in the illustrated embodiment, the SoC 600 includes an SMU input/output (IO) component 652.

The SoC 600 also includes a fusion controller hub (FCH) or a Southbridge I/O subsystem which handles many of the SoC 600 I/O functions and acts as a communication hub for peripherals that require less bandwidth than those handled by the NBIO subsystem 634. In the illustrated embodiment, the FCH includes components such as the FCH clock (CLK) 654 and FCH power blocks 656, 658. The FCH CLK 654, in some embodiments, includes clock generation circuitry or phase-locked loop (PLL) circuitry for generating a CLK signal for the various components of the SoC 600. For example, in some embodiments, the FCH CLK 654 operates in conjunction with the SMU 644 for CLK signal generation for the SoC 600. Thus, the FCH (including the FCH CLK 653 and FCH power blocks 656, 658) operates as the Southbridge component integrated within the SoC 600 and contains, in some cases, low bandwidth platform I/O controllers, system reset control logic, general purpose inputs/outputs (GPIOs) such as an FCH S5 power block 656 and FCH S0 power block 658, and clock generation blocks.

To manage various audio tasks on the SoC 600, the SoC 600 includes an audio coprocessor (ACP) 660 and ACP I/O 662. The ACP 660 offloads real-time audio processing tasks from other components of the SoC 600 that are important for low power use cases and provides optional support for device control to offload the main processor (e.g., one of the CCXs 602, 604). It also integrates industry standard audio codec interfaces to lower associated costs. In some embodiments, the ACP 660 includes increased SRAM size (e.g., in the range of 1 MB or more for primary memory and caches and 1 MB or more for secondary memory and caches) and multiple HiFi5 digital signal processors (DSPs).

In the illustrated embodiments, the SoC 600 also includes a plurality of power nodes 664 (only two labeled for clarity purposes) to implement the advanced power gating techniques described herein.

In some embodiments, the apparatus and techniques described above are implemented in a system including one or more integrated circuit (IC) devices (also referred to as integrated circuit packages or microchips), such as the components described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation-[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A system on chip comprising:
a plurality of central processing unit (CPU) core complexes, each CPU core complex of the plurality of CPU core complexes comprising a last level cache;
a parallel processor (PP) comprising a plurality of shader arrays; and
an inference processing unit (IPU) comprising a plurality of inference processing engines (IPEs),
wherein the system on chip is configured to operate within a thermal design power (TDP) envelope threshold.

2. The system on chip of claim 1, further comprising:
video encoder and decoder circuitry (VCN) comprising encoding circuitry for encoding one or more video frames to generate encoded bitstreams and decoding circuitry for decoding one or more video frames to generate decoded bitstreams;
display controller circuitry (DCN); and
an image sensor processor (ISP) comprising hardware to receive pixel data and write image processed data for subsequent processing.

3. The system on chip of claim 1, further comprising:
a memory controller (MC) to dispatch read and write requests to one or more memories on the system on chip; and
a data fabric (DF) for communicating data between one or more components of the system on chip.

4. The system on chip of claim 3, further comprising:
the one or more memories configured to store data associated with tasks performed by one or more other components of the system on chip.

5. The system on chip of claim 1, further comprising:
one or more first type of Universal Serial Bus (USB) components including at least one USB port and associated control circuitry; and
at least one other type of USB component including a respective port and associated control circuitry.

6. The system on chip of claim 1, further comprising:
a plurality of Peripheral Component Interconnect express (PCIe) interfaces and associated PCIe control circuitry.

7. The system on chip of claim 1, further comprising:
a system management unit (SMU) circuitry comprising memory protection and system protection circuitry and control circuitry for voltage and thermal control functions.

8. The system on chip of claim 7, wherein the SMU circuitry comprises:
a root of trust security processor configured to generate and protect root and certificate authority keys; and
a peripheral security processor configured to manage security-related tasks for peripheral components.

9. The system on chip of claim 1, further comprising:
one or more power multiplexers configured to select between different system on chip power operating modes.

10. The system on chip of claim 1, further comprising:
a fusion controller hub comprising low bandwidth platform input and output controllers, system reset control logic, general purpose inputs/outputs, and clock generation circuitry.

11. The system on chip of claim 10, wherein the fusion controller hub comprises:
a root of trust security processor configured to generate and protect root and certificate authority keys; and
a peripheral security processor configured to manage security-related tasks for peripheral components.

12. The system on chip of claim 1, further comprising:
an audio coprocessor (ACP) configured to offload real-time audio processing tasks from other components of the system on chip.

13. The system on chip of claim 1, wherein the plurality of CPU core complexes are arranged adjacent to one another, and wherein the parallel processor is adjacent to at least one CPU core complex of the plurality of CPU core complexes.

14. The system on chip of claim 1, wherein the plurality of CPU core complexes comprises:
a first central processing unit (CPU) core complex comprising a first last level cache (LLC) and a first plurality of cores; and
a second CPU core complex comprising a second LLC having a different capacity than the first LLC and a second plurality of cores.

15. The system on chip of claim 1, wherein the IPU comprises:
a plurality of memory circuits, each memory circuit of the plurality of memory circuits corresponding to a subset of the plurality of IPEs; and
a plurality of interface circuits,
wherein the plurality of IPEs is in a least one power domain and the plurality of interface circuits is in a second power domain different than at least one power domain of the plurality of IPEs.

16. The system on chip of claim 1, wherein the system on chip has dimensions to fit within a form factor threshold size.

17. A system on chip comprising:
a plurality of central processing unit (CPU) core complexes, each CPU core complex of the plurality of CPU core complexes comprising a last level cache;
a parallel processor (PP) comprising a plurality of shader arrays;
an inference processing unit (IPU) comprising a plurality of inference processing engines (IPEs);
video encoder and decoder circuitry (VCN) comprising encoding circuitry for encoding one or more video frames to generate encoded bitstreams and decoding circuitry for decoding one or more video frames to generate decoded bitstreams;
display controller circuitry (DCN); and
an image sensor processor (ISP) comprising hardware to receive pixel data and write image processed data for subsequent processing,
wherein the system on chip is configured to operate within a thermal design power (TDP) envelope threshold.

18. The system on chip of claim 17, further comprising:
a memory controller (MC) to dispatch read and write requests to one or more memories on the system on chip; and
a data fabric (DF) for communicating data between one or more components of the system on chip.

19. A system on chip comprising:
a plurality of central processing unit (CPU) core complexes, each CPU core complex of the plurality of CPU core complexes comprising a last level cache;
a parallel processor (PP) comprising a plurality of shader arrays;
an inference processing unit (IPU) comprising a plurality of inference processing engines (IPEs);
a memory controller (MC) to dispatch read and write requests to one or more memories on the system on chip;
a data fabric (DF) for communicating data between one or more components of the system on chip; and
a system management unit (SMU) circuitry comprising memory protection and system protection circuitry and control circuitry for voltage and thermal control functions,
wherein the system on chip is configured to operate within a thermal design power (TDP) envelope threshold.

20. The system on chip of claim 19, further comprising:
a fusion controller hub comprising low bandwidth platform input and output controllers, system reset control logic, general purpose inputs/outputs, and clock generation circuitry.
